(19) United States
(12) Patent Application Publication
(10) Pub. No.: US 2020/0202505 A1
(43) Pub. Date: Jun. 25, 2020

(54) DISPLAY PANEL DETECTION METHOD, APPARATUS AND SYSTEM

(71) Applicants: HKC Corporation Limited, Shenzhen (JP); Chongqing HKC Optoelectronics Technology Co., ltd., Chongqing (CN)

(72) Inventor: CHIA-JEN TSAI, Chongqing (CN)

(21) Appl. No.: 16/620,099

(22) PCT Filed: Jun. 20, 2017
(86) PCT No.: PCT/CN2017/089085

§ 371 Date: Dec. 6, 2019

(30) Foreign Application Priority Data
Jun. 7, 2017 (CN) 201710423085.8

(51) Int. Cl. G06T 7/00; G06T 1/00; H04N 5/247; G09G 3/36

(52) U.S. Cl. CPC G06T 7/001; G06T 1/0014; G06T 2207/30204; G09G 3/36; G06T 2207/30121; H04N 5/247

(57) ABSTRACT

A panel detection method, apparatus and system is disclosed. The method is to input supply voltage to the plurality of display panels display in the mother substrate; transmitting the preset drive signal to the plurality of display panel for displaying the screen image; acquiring screen image when displaying the preset screen image; detecting a screen image based on the predetermined detective defect rule to complete the screen detection. This method can quickly complete the screen detection of the display panel, to avoid the production line batch abnormalities.

### TECHNICAL FIELD

The present application relates to the field of display technology, and more particularly to a display panel detection method, apparatus and system.

### BACKGROUND OF RELATED ART

At present, the liquid crystal display panel is widely used in mobile phones, tablet PCs, computer monitors and other electronic equipment. In the process of the liquid crystal display panel, the lighting test process is a more important process in the liquid crystal display panel. The lighting test ensures the quality of the display panel, such as whether the display panel has bad points or not. The traditional liquid crystal display panel lighting test is the display panel from the mother substrate cut into a single display panel, a single display panel will be defective check out by a lighting test. This board detection method is very costly equipment and manpower. This single board detection method cannot detect the bad phenomenon of the product in real time, and cause the product batch bad phenomenon easily.

### SUMMARY

The embodiment of the present application provides a display panel detection method, apparatus and system, which is intended to solve the problem of time consuming and laboriousness of existing display panel inspection.

The present application provides a display panel detection method comprising: inputting a power supply voltage to a plurality of display panels in a mother substrate; transmitting a preset drive signal to the plurality of display panels to drive the display panel to display a preset test screen; gathering a screen image when the display panel displays the preset test screen; detecting the screen image according to a preset defect detection rule to complete screen detection of the plurality of display panels in the mother substrate.

The present application also provides a display panel detection apparatus comprising: an input unit for inputting a power supply voltage to a plurality of display panels in the mother substrate; a driving unit for transmitting a preset driving signal to the plurality of the display panels to drive the display panel to display a preset test screen; an acquisition unit for acquiring a screen image when the display panel displays the preset test screen; a detection unit for detecting the screen image according to a preset defect detection rule to complete screen detection of a plurality of display panels in the mother substrate.

The present application also provides a display panel detection system comprising: a lighting device, an image pickup device and a control device, the control device comprising: a memory that stores executable code; a processor that invokes the executable program code stored in said memory, performing the steps of: inputting a power supply voltage to a plurality of display panels in the mother substrate; transmitting a preset drive signal to the plurality of display panels to drive the display panel to display a preset test screen; gathering a screen image when the display panel displays the preset test screen; detecting the screen image according to a preset defect detection rule to complete screen detection of the plurality of display panels in the mother substrate.

The present embodiment provides a preset display signal by driving a power supply voltage to a plurality of display panels in a mother substrate; transmitting a preset drive signal to a plurality of the display panels for driving the display panel to display a preset test screen; gathering the display panel to display the screen image when the test screen is preset; detecting the screen image according to a preset defect detection rule to complete screen detection of a plurality of display panels in the parent substrate. The display panel detection method can quickly complete the screen detection of the display panel, but also to avoid the production line of the production panel batch abnormalities.

### BRIEF DESCRIPTION OF THE DRAWINGS

In order to provide a clearer description of the embodiments of the present application, the accompanying drawings, which are intended to be used in the description of the embodiments, will be briefly described. It will be apparent that the following description is a part of the present application. In the ordinary skill of the present invention, other drawings may be obtained in accordance with these drawings without paying creative work.

FIG. 1 is a schematic block diagram of a display panel detection system provided in an embodiment of the present application;

FIG. 2 is a schematic structural view of a lighting device and an image pickup apparatus provided in the present embodiment;

FIG. 3 is a schematic flow diagram of a display panel detection method provided in the embodiment of the present application;

FIG. 4 is another schematic flow diagram of a display panel detection method provided in the embodiment of the present application;

FIG. 5 is a schematic view of the planar structure of the mother substrate provided in the examples of the present application;

FIG. 6 is a schematic view of a captured screen image on the mother substrate at the time of screen detection provided in the embodiment of the present application;

FIG. 7 is a schematic block diagram of a display panel detection apparatus according to an embodiment of the present application;

FIG. 8 is one embodiment of the present application according to another schematic block diagram of a display panel detector.

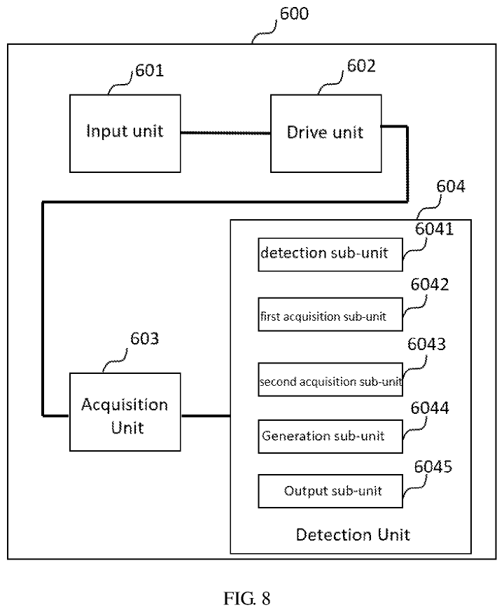

### DETAILED DESCRIPTION OF EMBODIMENTS

The embodiments described in the embodiments of the present application will be apparent from the following description of embodiments of the present application, and it will be apparent that the described embodiments are part of the embodiments of the present application and not all of the embodiments. Based on the embodiments of the present application, all other embodiments to those of ordinary skill in the art without any creative effort shall fall within the scope of the present application.

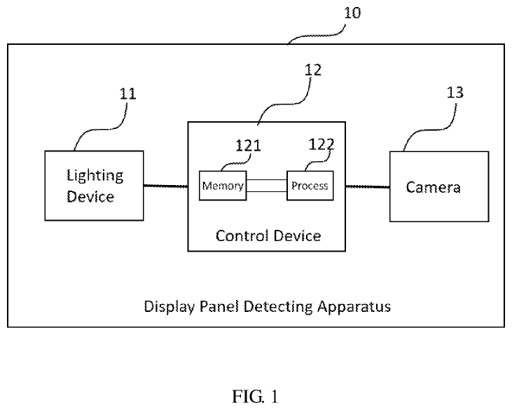

Please refer to FIG. 1. FIG. 1 is an embodiment of the present application provides one kind of detection system schematic block diagram of a display panel. The display panel 10 detection system comprises the lighting device 11, the control device 13 and the imaging device 12. The lighting device 11 and the imaging device 13 are connected with the main control device 12, the master device 12 for controlling the lighting device 11 to complete the display panel. And the image pickup apparatus 13 is used for photographing an image of the display panel in the screen detection.

It should be noted that the screen detection of the display panel is completed, and the screen detection is specifically a lighting test for the display panel for detecting whether the display panel is defective or not.

The control device 12 comprises a memory 121 and a processor 122, a memory 121, and a processor 122 coupled to each other. The memory 122 stores the executable program code; the processor 122 invokes the executable program code stored in the memory 121, executes:

inputting a power supply voltage to a plurality of display panels in a mother substrate;

transmitting a preset drive signal to the plurality of display panels to drive the display panel to display a preset test screen;

gathering a screen image when the display panel displays the preset test screen;

detecting the screen image according to a preset defect detection rule to complete screen detection of the plurality of display panels in the mother substrate.

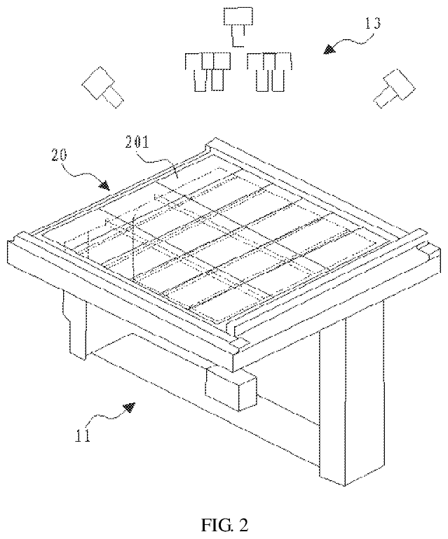

Specifically, as shown in FIG. 2, the lighting device 11 is used for simultaneously detecting a plurality of display panels 201 in the mother substrate 20, and the image pickup device 13 provided on the lighting device 11 acquires an image of a large mother substrate during picture detection. The display quality of each display panel is judged by the image, and a defective display panel is detected.

The image capturing apparatus 13 comprises a plurality of cameras, and a plurality of cameras are located above the mother substrate 20 on the lighting apparatus 11. The camera is, for example, a CCD (Charge Coupled Device) camera, and is not limited thereto, and may be other cameras.

The display panel detection system is a screen detection of a large mother substrate. Different from the existing screen detection system, the mother substrate lobes after a single display panel for screen detection. The display panel detection system can quickly and batch to complete the display panel of the screen detection, but also to avoid the production line of the production panel batch abnormalities.

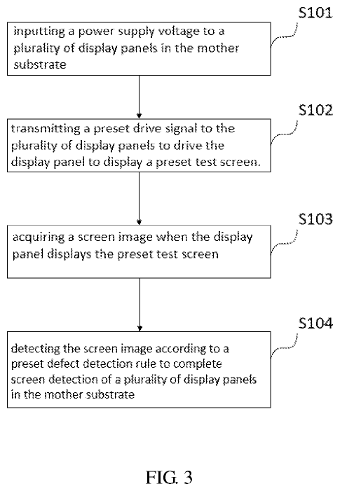

Referring to FIG. 3, FIG. 3 is a schematic flow chart of a display panel detection method provided in the embodiment of the present application. The display panel detection method is operated in a control device in the display panel detection system, and the control device controls the lighting device and the image pickup device by the display panel detection method, to simultaneously perform screen detection of a plurality of display panels in the mother substrate. The screen detection is for example, a lighting test of the display panel. As shown in FIG. 3, the display panel detection method includes steps S101 to S104.

S101: inputting a power supply voltage to a plurality of display panels in the mother substrate.

In an embodiment of the present application, specifically, a power supply voltage is input to a plurality of display panels in a mother substrate by a lighting device. The lighting device is used for simultaneously detecting a plurality of display panels in the mother substrate.

Specifically, the lighting device is used to mount a large-length mother substrate to simultaneously detect a plurality of display panels in the mother substrate. The mother substrate includes a plurality of display panels, and the mother substrate is lobed and subjected to a related process to produce a plurality of display panel products. The display panel includes, but is not limited to, a liquid crystal display panel.

Specifically, a plurality of display panels in the mother substrate are turn on by a lighting device, and a plurality of test thimble pins are provided on the lighting device. When the large mother substrate is mounted on the lighting fixture, the test thimble is connected to the test contact point on the display panel. The lighting device supplies the driving voltage to the display panel through the test thimble to turn on the display panel, i.e., input a power supply voltage to a plurality of display panels in the mother substrate.

S102: transmitting a preset drive signal to the plurality of display panels to drive the display panel to display a preset test screen.

In the embodiment of the present application, the preset driving signal is a signal for driving the display panel to display a preset test screen. For example, the display panel is driven to display a signal of a bright screen.

The preset test screen includes, but is not limited to, a preset picture, a preset dark picture, a preset red screen, a preset blue picture, and a preset green screen. Different preset test screens are used to detect different types of defects.

Specifically, a preset drive signal is transmitted to a plurality of the display panels to drive the display panel display preset test screen. The control device controls the lighting device to transmit to a plurality of the display panels in the mother substrate. The drive signal is preset to drive the display panel to display a preset test screen.

S103: acquiring a screen image when the display panel displays the preset test screen.

In the embodiment of the present application, the control device controls the image capturing apparatus to capture a screen image when the plurality of the display panels in the mother substrate display the preset test screen and transmit the screen image to the processor of the control device for related processing analysis.

Specifically, the step of acquiring the screen image when the display panel displays the preset test screen comprises acquiring the multiple screen images when the display panel displays the preset test screen from a plurality of angles by setting a plurality of cameras above the lighting device. Multi-angle can ensure that the display panel can be fully detected defects.

S104: detecting the screen image according to a preset defect detection rule to complete screen detection of a plurality of display panels in the mother substrate.

In an embodiment of the present application, the preset defect detection rules comprise a point defect detection rule, a line defect detection rule, and a spot defect (Mura defect) detection rule. The point defect detection rule is a rule method for detecting the presence point defect in the display panel, and the dot defect in the display panel can be detected. The line defect detection rule is also similar to the spot defect detection rule, which is used to detect midline defects and speckle defects (Mura defects) in the display panel.

The multiple screen images are acquired when the display panel displays the preset test screen from a plurality of angles by setting a plurality of cameras above the lighting device. Based on a preset defect detection rule, a plurality of picture images are detected to finish the screen detection of the plurality of display panels in the mother substrate.

The above-described embodiment of the present invention turns on a plurality of display panels in a mother substrate by a lighting device. The lighting device is used for simultaneously detecting a plurality of display panels in the mother substrate. A preset drive signal to the plurality of display panels is transmit to drive the display panel to display a preset test screen. A screen image is acquired when the display panel displays the preset test screen; the screen image is detected according to a preset defect detection rule to complete screen detection of a plurality of display panels in the mother substrate. The detection method of the display panel can simultaneously perform screen detection of a plurality of display panels, thereby the picture detection efficiency of the display panel is improved.

In addition, when the mother substrate is lobed into a single display panel. The display panel detection method can be detected online in real time, so it is possible to effectively avoid the batch abnormality in the display panel process.

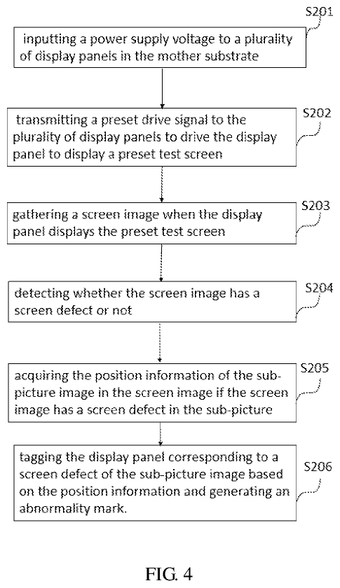

Referring to FIG. 4, FIG. 4 is another schematic flow diagram of a display panel detection method provided by the embodiment of the present application. The display panel detection method is run in a control device in the display panel detection system. The control device controls the lighting device and the image pickup device by the display panel detection method to simultaneously perform screen detection of a plurality of display panels in the mother substrate. As shown in FIG. 4, the display panel detection method includes steps S201 to S207.

S201: inputting a power supply voltage to a plurality of display panels in the mother substrate.

In the embodiment of the present application, in particular, a plurality of display panels are inputted to the main substrate by a power supply voltage by a lighting device, i.e., a plurality of display panels in the mother substrate are simultaneously turn on by the lighting device. The lighting device is used for simultaneously detecting a plurality of display panels in the mother substrate.

The lighting device is used for mounting a large mother substrate to simultaneously detect a plurality of display panels in the mother substrate. The mother substrate comprises a plurality of display panels, and the mother substrate is lobed and subjected to a related process to produce a plurality of display panel products. The display panel comprises, but is not limited to, a liquid crystal display panel.

S202: transmitting a preset drive signal to the plurality of display panels to drive the display panel to display a preset test screen.

In the embodiment of the present application, the preset driving signal is a signal for driving the display panel to display a preset test screen. For example, the display panel is driven to display a signal of a bright screen. The preset test screen comprises, but is not limited to, a preset picture, a preset dark picture, a preset red screen, a preset green screen, and a preset blue screen. Different preset test screens are used to detect different types of defects.

S203: gathering a screen image when the display panel displays the preset test screen. The screen image comprises a plurality of sub-picture images. The sub-picture images are captured when the display panel displays the preset test screen image.

In the embodiment of the present application, the screen image acquired when the display panel displays the preset test screen is that the control device controls the cameras to capture the plurality of screen images when the plurality of display panels displays the preset test images in the mother substrate.

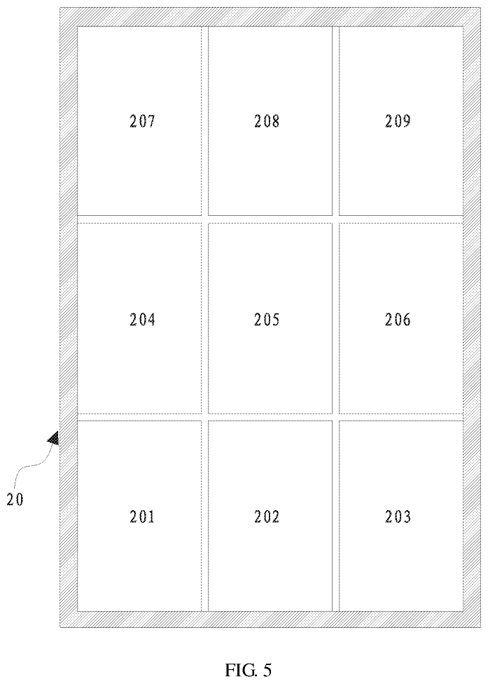

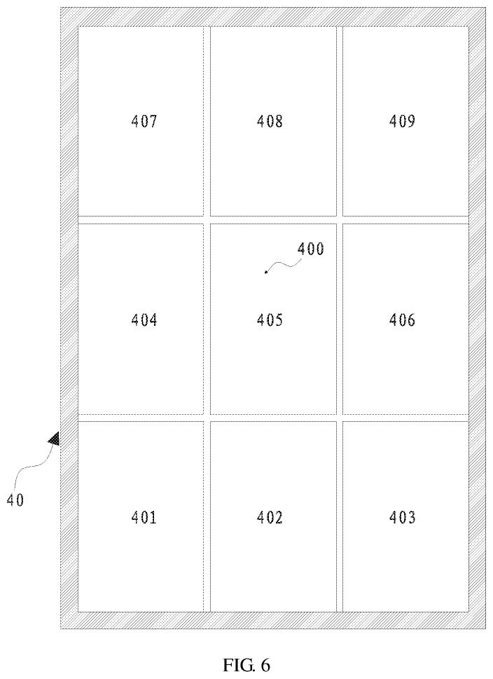

The screen image comprises a plurality of sub-picture images, and the sub-picture image is an image to be photographed when the preset test screen is displayed on the display panel. As shown in FIGS. 5 and 6, for example, the mother substrate 20 comprises a plurality of display panels, a display panel 201, a display panel 202, a display panel 203, a display panel 204, a display panel 205, a display panel 206, a display panel 207, a display panel 208 and a display panel 209. The screen image 40 comprises a sub-picture image 401, a sub-picture image 402, a sub-picture image 403, a sub-picture image 404, a sub-picture image 405, a sub-picture image 406, a sub-picture image 407, a sub-picture image 408, and a sub-picture image 409.

S204: detecting whether the screen image has a screen defect or not.

In the embodiment of the present application, it is detected whether there is a screen defect or not in the plurality of sub-picture images in the screen. The screen defects comprises, but are not limited to, point defects, line defects, and spot defects.

S205: acquiring the position information of the sub-picture image in the screen image if the screen image has a screen defect in the sub-picture.

In the embodiment of the present application, if there is a screen defect in the screen image, for example, a dot defect exists in the sub-picture image 405 of the screen image 40. Specifically, as shown in FIG. 6, a dark point 400 appears in the bright screen image.

It can also be other defect types such as line defects and spot defects.

The position information refers to a specific position of the sub-picture image in the screen image, such as a mother substrate comprises display panels. For example, the mother substrate comprises 3×3 array display panel to establish the coordinate system from the lower left corner of the mother substrate. The simplest way is that the reference position information is mark on the display panel of the mother substrate, for example, the display panel 201 or the display panel 205 and so on. The position information is used for prompt the user which has defect of the display panel specifically on the mother substrate.

Further, if there is a screen defect of the sub-picture image on the screen image, it is possible to acquire a screen defect type of the sub-picture image and to acquire the position information of the sub-picture image in the screen image at the same time. The screen defect type comprises a point defect, a line defect, or a spot defect.

S206: tagging the display panel corresponding to a screen defect of the sub-picture image based on the position information and generating an abnormality mark.

In the embodiment of the present application, the position information may be a mark of the display panel in the mother substrate, so that the display panel corresponding to the sub-picture image in which the screen defect exists is marked with the label, and an abnormality mark is generated. For example, if the sub-picture image 405 has a dot defect abnormality, the display panel 205 corresponding to the sub-picture image 405 is obtained, and the reference numeral 205 is generated as an abnormal mark.

S207: outputting the presentation information on the basis of the abnormality mark to prompt the detecting person that an abnormal display panel exists in the mother substrate.

In the embodiment of the present application, the presentation information is output on the basis of the abnormality mark to prompt the detecting person that an abnormal display panel exists in the mother substrate. For example, defective abnormality exists in the display panel 205 in the mother substrate 20.

Specifically, it is also possible to output the presentation information based on the abnormality mark number and the screen defect type, i.e. the presentation information can not only prompt which the display panel has abnormalities in the mother substrate, but also can indicate abnormal types, such as abnormal for the point of defects, to facilitate the detection of abnormal investigation.

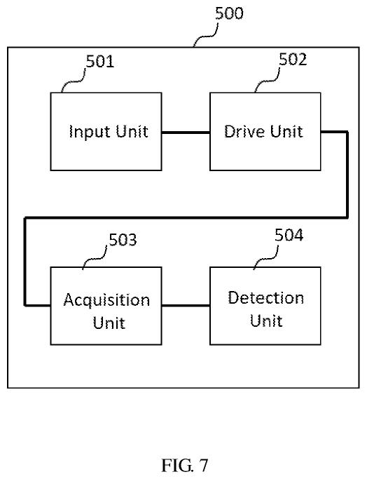

Referring to FIG. 7, FIG. 7 is a schematic block diagram of a display panel detection apparatus provided in the embodiment of the present application. As shown in FIG. 7, the display panel detection apparatus 500 comprises an input unit 501, a drive unit 502, an acquisition unit 503, and a detection unit 504.

An input unit 501 for inputting a power supply voltage to a plurality of display panels in the mother substrate.

Specifically, the power supply voltage is input through the lighting device to turn on a plurality of display panels in the mother substrate. A plurality of test thimble pins are provided on the lighting device. When the large mother substrate is mounted on the lighting device, the test thimble is connected to the test contact point on the display panel. The lighting device supplies the driving voltage to the display panel through the test thimble to turn on the display panel, i.e., input a power supply voltage to a plurality of display panels in the mother substrate.

A drive unit 502 for transmitting a preset drive signal to the plurality of display panels to drive the display panel to display a preset test screen.

Specifically, the preset driving signal is a signal for driving the display panel to display a preset test screen. For example, the display panel is driven to display a signal of a bright screen. The preset test screen comprises, but is not limited to, a preset picture, a preset dark picture, a preset red screen, a preset blue picture, and a preset red screen. Different preset test screens are used to detect different types of defects.

A acquisition unit 503 for acquiring a screen image when the display panel displays the preset test screen.

Specifically, a processor for capturing a screen image when the plurality of the display panels in the mother substrate displays the preset test screen and transmitting the screen image to the control device to perform correlation processing analysis.

In addition, the step of the screen image is captured when the display panel displays the preset test screen, comprises the plurality of screen images is acquired when the display panel displays the preset test image by setting the plurality of the cameras above the light device from the plurality of angles. Multi-angle can ensure that the display panel to detect defects fully.

A detection unit 504 is for detecting the screen image in accordance with a preset defect detection rule to complete screen detection of a plurality of display panels in the mother substrate.

In particular, the preset defect detection rules comprise a point defect detection rule, a line defect detection rule, and a spot defect detection rule. The point defect detection rule is a rule method for detecting the presence point defect in the display panel, and the point defect in the display panel can be detected. Line defect detection rules and dot defect detection rules are also similar, used to detect line defects and spot defects of the display panel.

Referring to FIG. 7, FIG. 7 is a schematic block diagram of a display panel detection apparatus provided in the embodiment of the present application. As shown in FIG. 7, the display panel detection apparatus 600 comprises an input unit 601, a drive unit 602, an acquisition unit 603, and a detection unit 604. The detection unit 604 comprises: a detecting sub-unit 6041, obtaining sub unit 6042, generating sub unit 6043 and output sub-unit 6044.

An input unit 601 is used for inputting a power supply voltage to a plurality of display panels in the mother substrate.

Specifically, a plurality of test pins are provided on the lighting device by inputting a power supply voltage to a plurality of display panels in the mother substrate by a lighting device. When the large mother substrate is mounted on the lighting fixture, the test thimble is connected to the test contact point on the display panel. The lighting device supplies the driving voltage to the display panel through the test thimble to turn on the display panel, i.e., inputting a power supply voltage to a plurality of display panels in the mother substrate.

A drive unit 602 for transmitting a preset drive signal to the plurality of display panels to drive the display panel to display a preset test screen.

Specifically, the preset driving signal is a signal for driving the display panel to display a preset test screen. For example, the display panel is driven to display a signal of a bright screen. The preset test screen comprises, but is not limited to, a preset picture, a preset dark picture, a preset red screen, a preset blue picture, and a preset red screen. Different preset test screens are used to detect different types of defects.

An acquisition unit 603 for acquiring a screen image when the display panel displays the preset test screen. The screen image comprises a plurality of sub-picture images. The sub-picture screen is a captured image when the display panel displays the preset test screen.

A detection unit 604 is used for detecting the screen image according to a preset defect detection rule to complete screen detection of a plurality of display panels in the mother substrate.

Specifically, the detection unit 604 comprises a detection sub-unit 6041, a first acquisition sub-unit 6042, a second acquisition sub-unit 6043, a generation sub-unit 6044, and an output sub-unit 6045.

A detection sub-unit 6041 is used for detecting whether a sub-picture image of a screen image has a screen defect or not.

Specifically, it is detected whether there is a screen defect exiting in the sub-picture images of the screen image or not. The screen defects comprise, but are not limited to, point defects, line defects, and spot defects.

A first acquisition sub-unit 6042 is used for acquiring position information of the sub-picture image of the screen image if the screen image has a screen defect in the screen image.

Specifically, the position information refers to a specific position of the sub-picture image in the picture image, such as a mother substrate comprises 3×3 display panel, and the coordinate system can be established from the lower left corner of the mother substrate. The simplest position information is the mark of the display panel of the mother substrate.

A second acquisition sub-unit 6043 is used for obtaining a screen defect type of the sub-picture image. The screen image has a screen defect in the sub-picture. The screen defect type comprises a dot defect, a line defect, or a spot defect.

A generating sub-unit 6044 is used for tagging the display panel corresponding to a screen defect of the sub-picture image based on the position information and generating an abnormality mark number.

Specifically, the position information may be a mark of the display panel in the mother substrate, so that the display panel is marked corresponding to the screen defect existing in the sub-picture image, and an abnormality mark is generated. For example, if one of the sub-picture images has a dot defect abnormality, the display panel corresponding to the sub-picture image is acquired, and the abnormal mark of the display panel is generated.

An output sub unit 6045 for outputting the presentation information based on the abnormality mark number to prompt the detection person that an abnormal display panel exists in the mother substrate.

Specifically, the presentation information is output based on the abnormality mark number and the screen defect type. The prompt information can not only indicate which the mother substrate is abnormal, but also may indicate an abnormal type, such as an abnormality as a point defect. The detectors are easy for abnormal investigation.

In an embodiment of the present application, the display panel may be, for example, an LCD display panel, an OLED display panel, a QLED display panel, a surface display panel, or other display panel.

It will be apparent to those skilled in the art that, for the sake of convenience and simplicity of description, the corresponding work of the described units can be referred to the corresponding process in the foregoing embodiment of the method and will not be described here further.

The steps in the method of the present application may be sequentially adjusted, merged and deleted according to actual needs.

The units in the apparatus of the present application can be combined, divided and deleted according to actual needs.

The foregoing is intended only as a specific embodiment of the present application, but the scope of protection of the present application is not limited thereto and it will be readily apparent to those skilled in the art that various equivalents may be readily apparent to those skilled in the art Modified or replaced, and such modifications or substitutions are intended to be included within the scope of the present application. Accordingly, the scope of protection of the present application is subject to the scope of protection of the claims.

What is claimed is:

1. A display panel detection method comprising:
inputting a power supply voltage to a plurality of display panels on a mother substrate;
transmitting a preset drive signal to the plurality of display panels for driving the display panel displaying a preset test screen;
acquiring a screen image when the preset test screen is displayed by the display panel; and
detecting the screen image according to a preset defect detection rule to complete screen detection of the plurality of display panels on the mother substrate.

2. The display panel detection method according to claim 1, wherein the screen image comprises a plurality of sub-picture images, the sub-picture image is an image to be photographed when the preset test screen is displayed on the display panel;
the screen image is detected according to the preset defect detection rule, comprising:
detecting whether a screen defect exits in the sub-picture images of the screen image;
acquiring position information of the sub-picture image in the screen image, if the screen image has the screen defect in the sub-picture image;
tagging the display panel corresponding to a screen defect of the sub-picture image based on the position information and generating an abnormality mark number; and
outputting a presentation information based on the abnormality mark to prompt the detecting person that an abnormal display panel exists in the mother substrate.

3. The display panel detection method according to claim 2, wherein after acquiring the position information of the sub-picture image in the screen image comprises:
acquiring a screen defect type of the sub-picture image, wherein the screen defect type comprises a dot defect, a line defect or a dot defect; and
the presentation information outputting based on the abnormality mark, and comprising: outputting a presentation information based on the abnormality mark and the screen defect type

4. The display panel detection method according to claim 1, wherein acquiring the screen image when the display screen is displayed the preset test screen, comprising:
acquiring a plurality of screen images when the preset display screen is displayed by the display panel through a plurality of cameras from a plurality of angles; and
detecting the screen image according to the preset defect detection rule, comprising detecting the plurality of picture images according to the preset defect detection rule.

5. The display panel detection method according to claim 1, wherein inputting the power supply voltage to the plurality of display panels in the mother substrate, comprising:
the power supply voltage is input to the plurality of display panels in the mother substrate by the lighting device.

6. The display panel detection method according to claim 5, wherein transmitting the preset drive signal to the plurality of display panels for drive the display panel to display the preset test screen, comprising:
controlling the lighting device to transmit the preset drive signal to the plurality of the display panels in the mother substrate to drive the display panel and to display the preset test screen.

7. The display panel detection method according to claim 1, wherein the preset test screen comprises a preset picture, a preset dark picture, a preset red screen, a preset green picture, and a preset blue picture.

8. The display panel detection method according to claim 7, wherein the preset defect detection rule comprises a dot defect detection rule, a line defect detection rule, and a spot defect detection rule.

9. A display panel detecting apparatus comprising:
an input unit for inputting a power supply voltage to a plurality of display panels in a mother substrate;
a driving unit for transmitting a preset driving signal to the plurality of the display panels for driving the display panel to display a preset test screen;
an acquisition unit for acquiring a screen image when the display panel displays the preset test screen; and
a detection unit for detecting the screen image according to a preset defect detection rule to complete screen detection of a plurality of display panels in the mother substrate.

10. The display panel detection apparatus according to claim 9, wherein the screen image comprises a plurality of sub-picture images, the sub-picture image is an image to be photographed when the preset test screen is displayed on the display panel;
the detection unit comprising:
a detection sub-unit for detecting whether the screen image has a screen defect in the sub-picture image or not;
a first acquisition sub-unit for acquiring the position information of the sub-picture image in the screen image if the screen image has the screen defect;
a generating sub-unit for tagging the display panel corresponding to the sub-picture image a screen defect existing in based on the position information and generating an abnormality mark number; and
an outputting sub-unit for outputting the presentation information based on the abnormality mark to prompt the detecting person that an abnormal display panel exists in the mother substrate.

11. The display panel detection apparatus according to claim 10, wherein the detection unit further comprises a second acquisition sub-unit;
the second acquisition sub-unit for obtaining a sub-picture image of a screen defect type, wherein the screen defect type comprises a dot defect, a line defect or a dot defect,
the outputting sub-unit is further configured to output the presentation information based on the abnormality mark and the screen defect type.

12. The display panel detection apparatus according to claim 9, wherein the acquisition unit is configured to acquire a plurality of screen images when the preset display screen is displayed by the display panel from a plurality of cameras through a plurality of angles;
the detection unit for detecting the plurality of picture images according to a preset defect detection rule.

13. The display panel detection apparatus according to claim 9, wherein the input unit is specifically configured to input a power supply voltage through a lighting device to the plurality of display panels in the mother substrate.

14. The display panel detecting apparatus according to claim 13, wherein the driving unit is specifically configured to control the lighting device to transmit a preset drive signal to a plurality of the display panels in the mother substrate for driving the display panel to display the preset test screen.

15. The display panel detection apparatus according to claim 9, wherein the preset test screen comprises a preset bright screen, a preset dark picture, a preset red screen, a preset green screen, and a preset blue picture.

16. The display panel detection apparatus according to claim 15, wherein the preset defect detection rule comprises a dot defect detection rule, a line defect detection rule, and a spot defect detection rule.

17. A display panel inspection system comprising a lighting device, an image pickup device, and a control device, wherein the control device comprises:
a memory storing executable code;
a processor invoking the executable program code stored in a memory to perform the steps of:
inputting a power supply voltage to a plurality of display panels in a mother substrate
transmitting a preset drive signal to the plurality of display panels for driving the display panel to display a preset test screen;
acquiring a screen image when the display screen displays the preset test screen;
detecting the screen image according to a preset defect detection rule to complete screen detection of the plurality of display panels in the mother substrate.

18. The display panel inspection system according to claim 17, wherein the screen image comprises a plurality of sub-picture images, the sub-picture image is an image to be photographed when the preset display screen is displayed on the display panel;
the processor invokes the executable program code stored in the memory, and further performs the steps of:
detecting whether a screen defect exits in the sub-picture images of the screen image;
acquiring position information of the sub-picture image in the screen image, if the screen image has the screen defect in the sub-picture image;
tagging the display panel corresponding to a screen defect of the sub-picture image based on the position information and generating an abnormality mark;
outputting a presentation information based on the abnormality mark to prompt a detecting person that an abnormal display panel exists in the mother substrate.

19. The display panel detection system according to claim 18, wherein the processor invokes the executable program code stored in the memory, further comprising the steps of:
obtaining a screen defect type of the sub-picture image, wherein the screen defect type comprises a dot defect, a line defect or a dot defect;
outputting the presentation information based on the abnormality mark, comprising: outputting a presentation information based on the abnormality mark and the screen defect type.

20. The display panel detection system according to claim 17, wherein the processor invokes the executable program code stored in the memory, and further performs the steps of:
acquiring the plurality of screen images when the preset display screen is displayed by the display panel by a plurality of cameras from a plurality of angles; and
detecting the plurality of picture images according to a preset defect detection rule.
